(19) United States
(12) Patent Application Publication
(10) Pub. No.: US 2023/0063628 A1
(43) Pub. Date: Mar. 2, 2023

(54) DIRECT CONTACT PRINTBAR CALIBRATION

(71) Applicant: HEWLETT-PACKARD DEVELOPMENT COMPANY, L.P., Spring, TX (US)

(72) Inventors: Kynan Lon Church, Vancouver, WA (US); Robert YRACEBURU, Vancouver, WA (US)

(73) Assignee: HEWLETT-PACKARD DEVELOPMENT COMPANY, L.P., Spring, TX (US)

(21) Appl. No.: 17/793,226

(22) PCT Filed: Jan. 31, 2020
(86) PCT No.: PCT/US2020/016211

§ 371 Date: Jul. 15, 2022

(51) Int. Cl. B41J 25/308

(52) U.S. Cl. CPC B41J 25/3088

(57) ABSTRACT

A printing system includes a printbar having an extension contact, a platen having a platen contact, and a controller to execute instructions. The instructions as executed by the controller cause the printbar to move toward the platen, monitor an adjustment mechanism indicating operation parameters of the adjustment mechanism, and set a reference position of the printbar in response to the parameter satisfying a threshold. A printing system comprising: a printbar including contact extension; a platen disposed opposite the printbar, the platen having a platen contact; and a controller to execute a set of instructions to: cause the printbar to move toward the platen; monitor an adjustment mechanism indicating operation parameters of the adjustment mechanism; and set a reference position of the printbar in response to the parameter of the adjustment mechanism satisfying a threshold.

### BACKGROUND

Printing systems, such as scanning printers, page wide printers, copiers, etc., may generate text or images on to print media (e.g., paper, plastic, etc.). Printing systems can utilize a print substance that can be deposited on to the print media to generate the text or images on the print media. Printing systems can utilize a printbar with a plurality of dies that can include a corresponding plurality of orifices to deposit a print substance on to the print media.

### BRIEF DESCRIPTION OF THE DRAWINGS

FIG. 1 is an example system for printbar spacing calibrations according to examples of the present disclosure.

FIG. 2 is an example system for printbar spacing calibrations according to examples the present disclosure.

FIG. 3 is an example system for printbar spacing calibrations according to examples the present disclosure.

FIG. 4 is an example system for printbar spacing calibrations according to examples the present disclosure.

FIG. 5 is a flow diagram illustrating an example method according to the present disclosure.

FIG. 6 is a flow chart illustrating an example calibration system according to the present disclosure.

### DETAILED DESCRIPTION

In some examples, a printing device can be utilized to generate an image on a print medium by depositing a print substance on to the print medium. For example, the printing device can include a page wide printing device, a scanning printing device, or other printing device. As used herein, a print substance can include a substance that is capable of generating an image on a print medium. For example, the print substance can include, but is not limited to, a fluid such as ink, a solid powder mixture such as toner, among other substances that can be utilized to generate images. As used herein, a print medium can be a substrate that can receive the print substance to generate a permanent or semi-permanent image. For example, a print medium can include, but is not limited to, paper, polymer, adhesive paper, metal, among other medias that can receive the print substance.

In some examples, a printing device can include a printbar or print head that includes a plurality of print dies or a plurality of orifices to deposit a print substance. As used herein, a printbar can include a mechanism that can deposit a print substance at particular locations on the print medium to generate the image to be printed on the print medium. A print head can include a mechanism that is capable of depositing a print substance on to a print medium. In some examples, the printbar and print head can be used interchangeably to describe a mechanism that can deposit a print substance onto a print medium. The printbar can include a plurality of print dies that each include orifices to deposit the print substance on to the print medium. In some examples, the plurality of print dies can be spaced along the printbar such that the plurality of print dies are capable of depositing the print substance across the entire surface of the print medium.

The printbar and corresponding print dies can be positioned at a particular distance from the print medium during printing operations (e.g., when the depositing print substance, etc.). This distance is referred to herein as pen to paper spacing and can have an effect on the print quality of images generated on the print medium. In some examples, the printing device can include a pen to paper spacing value that can be a manufacturer pen to paper spacing value (e.g., pen to paper spacing value utilized by the manufacturer, etc.) that the printing device is manufactured with by the manufacturer. In some examples, the manufacturer setting of the pen to paper spacing value can be considered a nominal pen to paper spacing value.

Manufacturer settings may have large tolerances between the printbar and the platen that result in setting a larger distance than would cause optimal performance to prevent the printbar from contacting media or other components of the printing system. Additionally, different printers may have different performance characteristics based on variance in manufacturing of the systems. Calibration and adjustment of pen to paper spacing in a manufacturing setting can use substantial resources, tooling, and have errors. These calibrations may also be affected by shipping, installation, and use over time.

The present disclosure relates to printbar spacing calibrations generated based on datuming the printbar to the platen based on contact made between components of the printbar and platen. In some examples, the printbar is lowered toward the platen as a controller monitors an adjustment mechanism that lowers the platen. When a portion of the printbar contacts a portion of the platen, a parameter of the adjustment mechanism's operation may change. For example, a stress or strain gauge may indicate a change in a force or a voltage or current monitor may note a change in electrical load used by the adjustment mechanism. In some examples, a stress or strain gauge may monitor another position rather than the adjustment monitor.

In order to ensure no damage to print dies while contacting the platen, the printbar may have extension contacts aligned to contact a set portion of the platen. For example, the extension contacts may be aligned to contact feed rollers associated with the platen, bearings of the feed rollers, or the platen itself. In some examples, there may be a single extension contact, however multiple extension contacts may provide data at either side of the printbar based on their contact. In some examples, the extension contacts may be integral to a portion of the printbar, or they may be attached as separate structures. In some examples, various components of the platen may be used as contact points in addition to those discussed herein. For example, the platen may have additional extension contacts to contact the printbar.

Based on the position of the printbar with respect to the platen that the contact is detected, the printing system can store that value. For example, a motor that moves the printbar may have an encoder that provides a value indicating the relative position of the printbar. The position of contact can then be used as a reference point to move the printbar a preset distance back from the platen to provide an accurate pen to paper spacing for printing operations.

Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

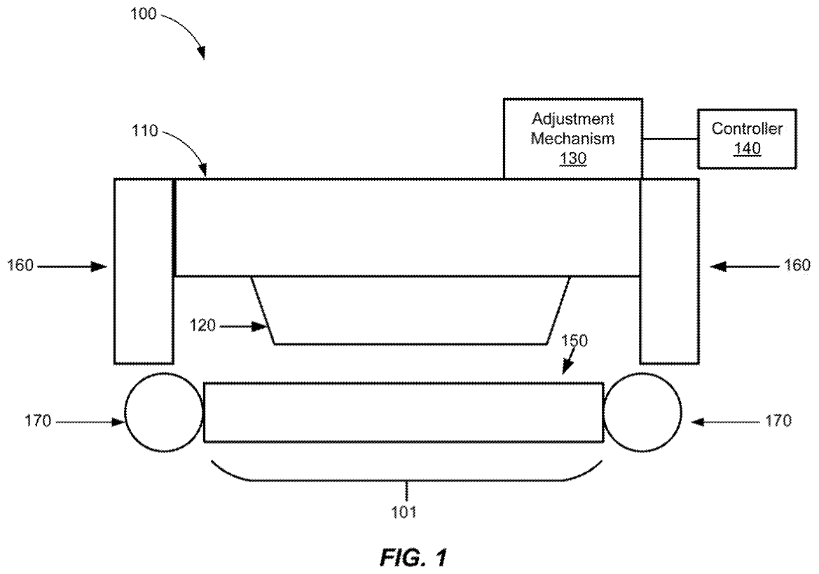

FIG. 1 is a block diagram illustrating components of an example printing system 100 for printbar spacing calibrations consistent with the present disclosure. The example printing system 100 includes a print zone 101. In these examples, the print zone 101 can be a portion of the printing system 100 where a print substance is deposited on to a print media. The printing system 100 includes a printbar 110 that includes print dies 120 (or pens including print dies), or the like, to apply printing substance to print media.

In some examples, the print zone 101 can include a platen 150 to support print media through the print zone 101. Print media may be directed across the platen 150 by one or more feed rollers 170. The spacing between the platen 150 and the print dies 120 may be representative of the pen to paper spacing that is experienced during printing operations. As described herein, pen to paper spacing can affect the print quality of images generated by the printing device 100.

The printing system 100 includes an adjustment mechanism 130 to alter a distance between the printbar 110 and the platen 150 in order to adjust pen to paper spacing. In some examples, the adjustment mechanism 130 can alter the position of the printbar 110 in fixed increments (e.g., 0.1 millimeter increments, 0.2 millimeter increments, etc.). In other examples, the adjustment mechanism 130 can alter the pen to paper spacing in a continuous way such that the alteration can be a non-fixed increment (e.g., slides down a rail, lowered along a rail system, etc.).

The adjustment mechanism 130 is communicatively coupled to a controller 140 to control the adjustment mechanism 130 to position the printbar 110. In some examples, the controller 140 may controller other operations of the printing system 100 such as drive mechanisms, ejection of printing fluids, image analysis, conditioning, or the like. As described herein, the controller 140 can include a number of processing resources capable of executing instructions stored by a memory resource. The memory resource, as used herein, can include a number of memory components capable of storing non-transitory instructions that can be executed by the controller 140.

In some examples, the controller 140 can determine a plurality of pen to paper spacing values to be utilized for different types of print media, types of print jobs, or the like. The printing system 100 may position print bar 110 to those pen to paper spacing values based on a reference position determined based on datuming of the printbar to the platen 150.

In order to determine a reference position of the printbar 110 with respect to the platen, the controller 140 may instruct the adjustment mechanism 130 to move toward the platen 150 while monitoring one or more parameters of the adjustment mechanism 130. In some examples, one or more sensors or sensing circuits may be provide signals for the controller 140 to monitor indicative of parameters of the adjustment mechanism 130. For example, as shown in FIG. 1, extension contacts 160 are aligned to contact feed rollers 170 when the printbar 110 is lowered far enough. The adjustment mechanism 130 may experience an increased electrical load based on the contact or a stress or strain gauge may register a change in the stress or strain experienced based on the contact. The controller 140 may determine based on monitored signals, that the printbar extension contacts 160 have contacted the feed rollers 170. At that time, the printbar can store an encoder value of the extension mechanism 130 and use that encoder value as representative of a reference position for a lower bound of the print bar. Accordingly, to later set pen to paper spacing, a predetermined offset from the stored encoder value can provide accurate pen to paper spacing with low tolerance.

In some examples, the extension contacts 160 may be manufactured such that the print dies 120 cannot contact the platen prior to the extension contacts 160. Accordingly, the print dies 120 are protected from potential damages from being driven into to platen.

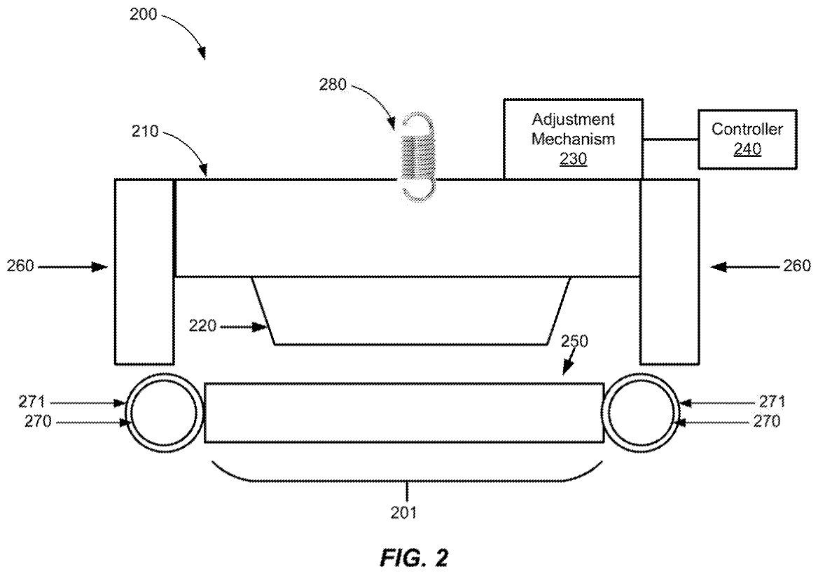

FIG. 2 is a block diagram illustrating components of an example printing system 200 for printbar spacing calibrations consistent with the present disclosure. The printing system 200 may be similar to the printing system 100 discussed above with reference to FIG. 1 with additional components illustrated. The numbering system for FIG. 2 is such that the leading digit is a reference to the Figure, while the following digits represent similar corresponding components. For example, the printbar 210 in FIG. 2 is the same or similar to the printbar 110 as described with reference to FIG. 1. Accordingly, details of corresponding components are not discussed in detail with respect to FIG. 2.

In FIG. 2, the feed rollers 270 include bearings 271. Accordingly, as the adjustment mechanism 230 lowers the print bar toward the platen 250, the extension mechanisms contact the bearings 271 rather than resting directly on a shaft of feed roller 270. This may reduce potential damage or wear on the feed roller 270. Additionally, the printbar 210 may be partially supported by one or more springs 280. This can reduce the load carried by the adjustment mechanism 230 as well as the load experienced by shafts of feed roller 270, further reducing potential wear on components of the printing system 100.

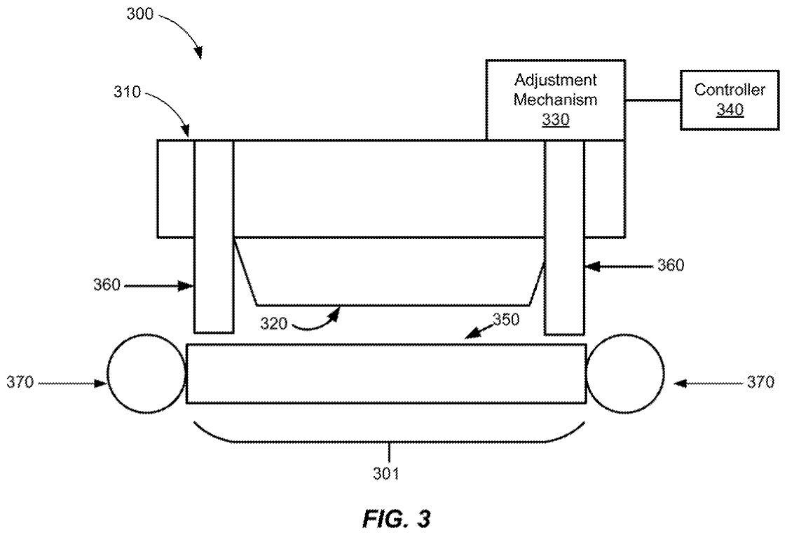

FIG. 3 is a block diagram illustrating components of an example printing system 300 for printbar spacing calibrations consistent with the present disclosure. The printing system 300 may be similar to the printing system 100 discussed above with reference to FIG. 1 with alterations to some components illustrated. The numbering system for FIG. 3 is such that the leading digit is a reference to the Figure, while the following digits represent similar corresponding components. For example, the printbar 310 in FIG. 3 is the same or similar to the printbar 110 as described with reference to FIG. 1. Accordingly, details of corresponding components are not discussed in detail with respect to FIG. 3.

In FIG. 3, the contact extensions 360 are aligned to directly contact the platen 350. Accordingly, the contact extensions 360 do not contact the feed rollers 370 as discussed with respect to FIGS. 1 and 2 above. In some example, the contact extensions 370 may be aligned to contact particular portions of platen 350 that are unlikely to be damaged or wherein damage is unlikely to change operation of the printing system 300. In various examples, not shown, the contact extensions 360 may be aligned to contact other portions of the platen 370 or associated components that are stationary with respect to the platen 370. In addition, in some examples, there may be contact extensions attached to a component of the platen but not in the paper feed path, or on both the platen and the printbar 310.

Although each of the printbars 110, 210, and 310, are shown having two contact extensions, in various examples, there may be fewer or additional contact extensions. For example, a single contact extension may be sufficient and simpler to manufacture and design. Furthermore, there could be contact extensions on each side of the printbars 110, 210, and 310, in both the direction of the paper feed path and perpendicular to the paper feed path. Additionally, different combinations of elements in FIGS. 1, 2, and 3 may be combined in various examples. For instance, a printing system 200 may include either a spring 280 or bearings 271 without having both. As an additional example, the printing system 300 may include a spring to support the printbar 310 as discussed with reference to FIG. 2.

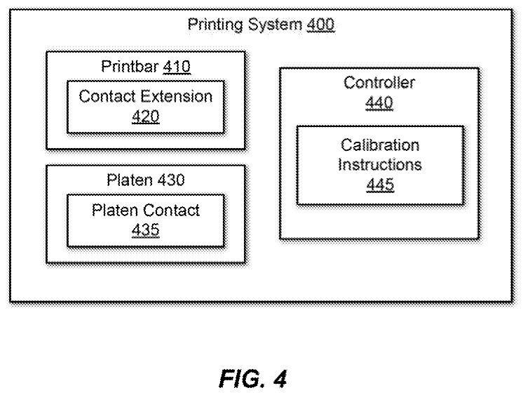

FIG. 4 is a block diagram illustrating an example system printing system 400 for calibrating pen to paper spacing based on contact datuming between a printbar 410 and a platen 430. The controller 440 executes calibration instructions 445 to calibrate the position between the printbar 410 and the platen 430 to a reference position to use for pen to paper spacing during printing operations. The printbar 410 may be the same or similar to the printbars 110, 210, and 310 discussed with reference to the figures above and the platen 430 may be the same or similar to the platens 150, 250, and 350 as discussed with respect to the Figures above.

The controller 440 executes the calibration instructions 445 to move the printbar 410 toward the platen 150. For example, the controller 440 may cause an adjustment mechanism, such as a motor, to move the printbar 410 toward the platen 430. The adjustment mechanism may include an encoder indicating a relative position of the mechanism as it moves. As the printbar 410 approaches the platen 430, the controller 440 monitors operation parameters of an adjustment mechanism, when an extension contact 420 of the printbar 410 contacts a platen contact 430 435, the controller 440 stops movement of the printbar 410. The encoder position of the adjustment mechanism at that point can be used as a reference position indicating a minimum distance between the printbar 410 and the platen 450. The controller 440 can then instruct the adjustment mechanism to move a determined distance from the reference position to a pen to spacing distance for printing operations.

The extension contact 420 may be located on a component of printbar 410 or included as integral to a component of the printbar. The platen contact 435 may be a feed roller as shown in FIG. 1, the platen itself as shown in FIG. 3 or may be another component in a fixed position relative to the platen 410. In various examples, the operation parameters of the adjustment mechanism monitored by controller 440 may be representative of stress or strain experienced by the adjustment mechanism or the printbar 410. In some examples, an electrical signal indicating the load on the adjustment mechanism may be used as the monitored operation parameter,

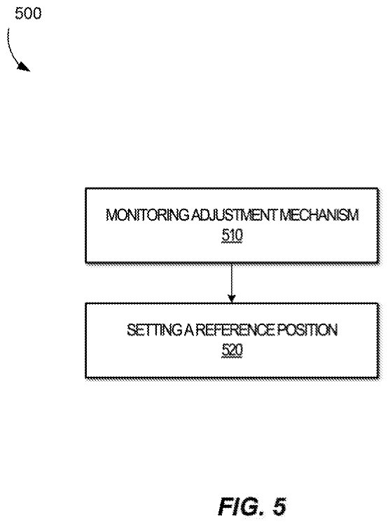

FIG. 5 is a flow diagram illustrating an example method to calibrate printbar spacing according to the present disclosure. For example, the method may be performed by the components of a printing system or calibration system as described with reference to FIGS. 1-4 above. In various examples, the processes described in reference to flow diagram 500 may be performed in different order or the method may include fewer or additional blocks than are shown in FIG. 5.

Beginning in block 520, a printing system monitors an adjustment mechanism that moves a printbar to determine if the printbar is within a threshold proximity of a platen. For example, the threshold may be set as an indication that the adjustment mechanism is experiencing an increased load due to a contact extension of the printbar contacting a platen contact of the platen. The monitoring may monitor an electric current or voltage that senses the load on a motor, for instance. In some examples, the controller may monitor a stress or strain gauge rather than monitoring the adjustment mechanism. In some examples, the printbar may be moved to determine the reference position in response to installation of a printbar, start-up of a printing system, at predetermined intervals, in response to certain events, or at other times.

In block 540, the printing system sets a reference position of the printbar in response to the electrical signal satisfying the threshold. For example, the reference position may be based on an encoder value of the adjustment mechanism as the threshold is satisfied. After the reference position of the printbar is set based on datuming of the printbar to the platen, the printing system can use the reference position and predetermined pen to paper spacing settings to adjust the position of the printbar to a spacing enabling printing operations.

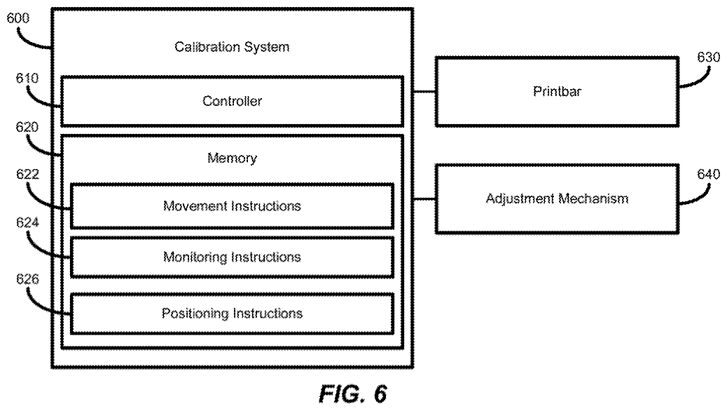

FIG. 6 is a block diagram illustrating an example calibration system 600 of a printing system according to the present disclosure. Calibration system 600 may include at least one computing device that is capable of communicating with at least one remote system. In the example of FIG. 6, calibration system 600 includes a controller 610 and a memory 620. Although the following descriptions refer to a single processor and a single computer-readable medium, the descriptions may also apply to a system with multiple processors and computer-readable mediums. In such examples, the instructions may be distributed (e.g., stored) across multiple computer-readable mediums and the instructions may be distributed (e.g., executed by) across multiple processors. Controller 610 may be a central processing unit (CPUs), a microprocessor, and/or other hardware devices suitable for retrieval and execution of instructions stored in memory 620. In the example calibration system 600, controller 610 may receive, determine, and send movement instructions 622, monitoring instructions 624, and positioning instructions 626 to calibrate pen to paper spacing of a printbar for a printing system. As an alternative or in addition to retrieving and executing instructions, controller 610 may include an electronic circuit comprising a number of electronic components for performing the functionality of an instruction in memory 620. With respect to the executable instruction representations (e.g., boxes) described and shown herein, it should be understood that part or all of the executable instructions and/or electronic circuits included within a particular box and/or may be included in a different box shown in the figures or in a different box not shown. Memory 620 may be any electronic, magnetic, optical, or other physical storage device that stores executable instructions. Thus, memory 620 may be for example, Random Access Memory (RAM), an Electrically-Erasable Programmable Read-Only Memory (EEPROM), a storage drive, an optical disc, and the like. Memory may be disposed within printing system 100, 200, 300, or 400 as shown in FIGS. 1-4. In this situation, the executable instructions may be “installed” on the system 600.

Movement instructions 622 stored on memory 620 may, when executed by controller 610, cause the controller 610 to cause a printbar 630 to move toward a platen of a printing system. The monitoring instructions 624 stored on memory 620 may, when executed by controller 610, cause the controller 610 to monitor an operating parameter of adjustment monitor 640 to set a reference position of the printbar 630. For example, the reference position may be set based on the operating parameter (or a signal representative of an operating parameter) satisfying a threshold indicating a proximity between the printbar and the platen. The position instructions 626, when executed by controller 610, may cause the controller 610 to position the printbar based on the reference position to a predetermined pen to paper spacing position. Accordingly, the printbar may be positioned in a proper spacing to improve print quality as well as reduce potential damage to components of the printing system. In addition to the operations discussed, memory 620 may include additional instructions that enable additional systems and operations as described herein. For example, those processes described with respect to FIG. 1-3 may be performed based on instructions stored on memory 620.

It will be appreciated that examples described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. In various examples other non-transitory computer-readable storage medium may be used to store instructions for implementation by processors as described herein. Accordingly, some examples provide a program comprising code for implementing a system or method as claimed in any preceding claim and a machine-readable storage storing such a program.

The features disclosed in this specification (including any accompanying claims, abstract and drawings), and/or the operations or processes of any method or process so disclosed, may be combined in any combination, except combinations where at least some of such features and/or processes are mutually exclusive.

Each feature disclosed in this specification (including any accompanying claims, abstract, and drawings), may be replaced by alternative features serving the same, equivalent or similar purpose, unless expressly stated otherwise. Thus, unless expressly stated otherwise, each feature disclosed is an example of a generic series of equivalent or similar features

1. A printing system comprising:
a printbar including contact extension;
a platen disposed opposite the printbar, the platen having a platen contact; and
a controller to execute a set of instructions to:
cause the printbar to move toward the platen;
monitor an adjustment mechanism indicating operation parameters of the adjustment mechanism; and
set a reference position of the printbar in response to the parameter of the adjustment mechanism satisfying a threshold.

2. The printing system of claim 1, further comprising the adjustment mechanism coupled to the printbar to move the printbar based on instructions received from the controller.

3. The printing system of claim 1, wherein the reference position is based on an encoder reading of the adjustment mechanism when the threshold his satisfied.

4. The printing system of claim 1, wherein the contact extension is aligned to contact feed rollers associated with the platen.

5. The printing system of claim 1, wherein the contact extension is aligned to contact the platen directly.

6. The printing system of claim 1, there are a plurality of contact extensions disposed on either side of the printbar.

7. The printing system of claim 1, wherein the contact extensions are formed integrally to a component of the printbar.

8. The printing system of claim 1 wherein the printbar is partially supported by a spring and the contact extension is aligned to contact bearing associated with feed rollers of the platen.

9. The printing system of claim 1, wherein the threshold is based on one of electrical load of the adjustment mechanism or force exerted by the adjustment mechanism.

10. A method comprising:
monitoring an adjustment mechanism of a printbar to determine that the printbar is within a threshold proximity of a platen; and
setting a reference position of the printbar in response to the satisfying the threshold.

11. The method of claim 10, further comprising adjusting the position of the printbar with respect to the reference position to a predetermined pen to paper spacing position.

12. The method of claim 10, further comprising monitoring the adjustment mechanism in response to installation of the printbar or start up of a printing system.

13. The method of claim 10, wherein setting the reference position of the printbar comprising storing an encoder value associated with an adjustment mechanism that moves the printbar.

14. A calibration system comprising:
a memory to store a set of instructions; and
a controller to execute the set of instructions to:
cause a printbar to move toward a platen of a printing system;
monitor an adjustment mechanism to set a reference position of the printbar
position the printbar based on the reference position to a predetermined pen to paper spacing position.

15. The calibration system of claim 14, wherein to set the reference position, the controller is further to determine an encoder position of an adjustment mechanism.
